(19) United States
(12) Patent Application Publication
(10) Pub. No.: US 2018/0299763 A1
(43) Pub. Date: Oct. 18, 2018

(54) INFORMATION PROCESSING APPARATUS, OBJECT INFORMATION ACQUIRING APPARATUS, AND INFORMATION PROCESSING METHOD

(71) Applicant: CANON KABUSHIKI KAISHA, Tokyo (JP)

(72) Inventor: Ryosuke Amano, Tokyo (JP)

(21) Appl. No.: 15/943,835

(22) Filed: Apr. 3, 2018

(30) Foreign Application Priority Data
Apr. 14, 2017 (JP) 2017-080603

(51) Int. Cl. G03B 42/06; G06K 9/32; G06T 7/73; G01S 15/89

(52) U.S. Cl. CPC G03B 42/06; G01S 15/8965; G06T 7/73; G06K 9/3233

(57) ABSTRACT

An information processing apparatus, comprises a first acquiring unit that acquires a photoacoustic image generated base d on an acoustic wave which is generated by light irradiation; a second acquiring unit that acquires an ultrasonic image generated based on a reflected wave of an ultrasonic wave transmitted to the object; a determining unit that determines a high accuracy region that is a region in which information is acquired with at least a predetermined accuracy in the photoacoustic image; an input unit that accepts a specification of a region of interest (ROI) on the ultrasonic image; and a displaying unit that displays the ultrasonic image and the photoacoustic image corresponding to the ROI, wherein when the inputting unit accepts the specification of the ROI, the displaying unit displays the position of the high accuracy region on the ultrasonic image in a superimposed state.

### BACKGROUND OF THE INVENTION

### Field of the Invention

The present invention relates to an apparatus that processes an image acquired by imaging an object.

### Description of the Related Art

Research on imaging structural and biological information (functional information) inside an object is ongoing in medical fields. Photoacoustic tomography (PAT) is one such technique that has been proposed.

If light, such as laser light, is irradiated to a living body (object), an acoustic wave (typically an ultrasonic wave) is generated when the light is absorbed by a biological tissue inside the object. This phenomenon is called the “photoacoustic effect”, and the acoustic wave generated by the photoacoustic effect is called a “photoacoustic wave”. The tissues constituting the object have different absorption ratios of light energy, hence the generated photoacoustic waves also have different sound pressures. With PAT, a generated photoacoustic wave is received by a probe, and the received signal is mathematically analyzed, so as to acquire characteristic information inside the object.

For example, Japanese Patent Application Publication No. 2014-100456 discloses a photoacoustic apparatus that acquires the oxygen saturation degree and fat concentration uses this information for diagnosis. Further, Japanese Patent Application Publication No. 2010-12295 discloses an object information acquiring apparatus that simultaneously acquires a photoacoustic image generated by imaging the object information, and an image information of the object based on the ultrasonic wave (ultrasonic image).

### SUMMARY OF THE INVENTION

A possible information presenting method in the case of simultaneously acquiring the photoacoustic image and the ultrasonic image is a method of an operator specifying a region of interest (hereafter ROI) on an ultrasonic image, and displaying the photoacoustic image in the specified region.

In a photoacoustic apparatus which is normally used, a signal becomes weaker and becomes undistinguishable from noise as the distance of the target segment from the skin increases. This is because the transmittance of the light in the living body becomes low, and the deeper in the living body, the harder it becomes to obtain a sufficient intensity of an acoustic wave. In other words, a region from which an accurate photoacoustic image can be acquired is limited to a portion close to the skin (shallow portion).

The apparatus according to Japanese Patent Application Publication No. 2010-12295, however, cannot visually present the operator a region from which a sufficiently accurate photoacoustic image can be acquired. In other words, accuracy of the photoacoustic image that can be acquired is unknown in advance when a target region is specified.

With the foregoing in view, it is an object of the present invention to improve usability in an apparatus which displays both an ultrasonic image and a photoacoustic image.

The present invention in its one aspect provides an information processing apparatus, comprising a first acquiring unit configured to acquire a photoacoustic image that is an image generated on a basis of an acoustic wave which is generated by irradiating an object with light; a second acquiring unit configured to acquire an ultrasonic image that is an image generated on a basis of a reflected wave of an ultrasonic wave transmitted to the object; a determining unit configured to determine a high accuracy region that is a region in which information is acquired with at least a predetermined value of accuracy in the photoacoustic image; an inputting unit configured to receive a designation of a region of interest on the ultrasonic image; and a displaying unit configured to display the ultrasonic image and the photoacoustic image corresponding to the region of interest, wherein in a case the inputting unit receives the designation of the region of interest, the displaying unit displays the position of the high accuracy region on the ultrasonic image in a superimposed state.

The present invention in its another aspect provides an information processing method, comprising a first acquiring step of acquiring a photoacoustic image that is an image generated on a basis of an acoustic wave which is generated by irradiating an object with light; a second acquiring step of acquiring an ultrasonic image that is an image generated on a basis of a reflected wave of an ultrasonic wave transmitted to the object; a determining step of determining a high accuracy region that is a region in which information is acquired with at least a predetermined value of accuracy in the photoacoustic image; an inputting step of receiving a designation of a region of interest in the ultrasonic image; and a displaying step of displaying the ultrasonic image and the photoacoustic image corresponding to the region of interest by using the displaying unit, wherein when the designation of the region of interest is received in the inputting step, the displaying unit displays the position of the high accuracy region on the ultrasonic image in a superimposed state.

According to the present invention, the usability can be improved in an apparatus which displays both an ultrasonic image and a photoacoustic image.

Further features of the present invention will become apparent from the following description of exemplary embodiments with reference to the attached drawings.

### BRIEF DESCRIPTION OF THE DRAWINGS

FIG. 1 is a functional block diagram of an object information acquiring apparatus according to Embodiment 1;

FIG. 2 is a diagram depicting an imaging range inside an object;

FIG. 3 is a flow chart depicting a flow of an imaging processing for the object;

FIG. 4 is a diagram depicting an ROI settable range according to Embodiment 1;

FIG. 5 is an example of an ROI setting screen according to Embodiment 1;

FIG. 6 is a display example of the photoacoustic image according to Embodiment 1;

FIG. 7 is an example of an ROI setting screen according to Embodiment 2;

FIG. 8 is an example of an ROI setting screen according to Embodiment 3; and

FIG. 9 is a display example of a photoacoustic image according to Embodiment 3.

### DESCRIPTION OF THE EMBODIMENTS

Preferred embodiments of the present invention will be described with reference to the drawings. Dimensions, materials, shapes and relative dispositions of the components described below can be appropriately changed depending on the configuration and various conditions of the apparatus to which the invention is applied. Therefore the following description is not intended to limit the scope of the present invention.

An object information acquiring apparatus of the present invention is an apparatus utilizing the photoacoustic effect, which irradiates an object with light (electromagnetic wave), receives an acoustic wave generated inside the object, and acquires characteristic information on the object as image data. In this case, the characteristic information is information on characteristic values which are generated using receive signals obtained by receiving the photoacoustic wave, and which correspond to a plurality of positions inside the object respectively.

The characteristic information acquired by the photoacoustic measurement are values reflecting the absorption ratios of the light energy. For example, the characteristic information includes a generation source of the acoustic wave generated by the light irradiation, the initial sound pressure inside the object, or the light energy absorption density or the absorption coefficient derived from the initial sound pressure, and the substance concentration constituting the tissue.

By determining the oxyhemoglobin concentration and the deoxyhemoglobin concentration as the substance concentration, the oxygen saturation distribution can be calculated. Glucose concentration, collagen concentration, melanin concentration, and volume fractions of fat and water can also be determined. Further, a substance of which light absorption spectrum is characteristic, such as a contrast medium (e.g. indocyanine green (ICG)) administered into the body, can also be a subject of determining substance concentration.

The object information acquiring apparatus according to the present invention includes an apparatus utilizing an ultrasonic echo technique which acquires object information as image data by transmitting an ultrasonic wave to an object, and receiving a reflected wave (echo wave) thereof reflected inside the object. In this case, the object information to be acquired is information reflecting the difference of the acoustic impedance of the tissue inside the object.

Based on the characteristic information at each position inside the object, a two-dimensional or three-dimensional characteristic information distribution is acquired. The distribution data can be generated as image data. The characteristic information may be determined as distribution information at each position inside the object, instead of as numeric data. In other words, such distribution information as the initial sound pressure distribution, the energy absorption density distribution, the absorption coefficient distribution, and the oxygen saturation distribution, may be determined as the characteristic information.

The acoustic wave in the present description is typically an ultrasonic wave, including an elastic wave called a “sound wave” and an “acoustic wave”. An electric signal, which was converted from an acoustic wave by a probe or the like, is called an “acoustic signal”. Such phrases as ultrasonic wave or acoustic wave in this description, however, are not intended to limit the wavelengths of these elastic waves. An acoustic wave generated by the photoacoustic effect is called a “photoacoustic wave” or a “light-induced ultrasonic wave”. An electric signal, which originates from the photoacoustic wave, is called a “photoacoustic signal”. An electric signal, which originates from an ultrasonic echo, is called an “ultrasonic signal”.

### Embodiment 1

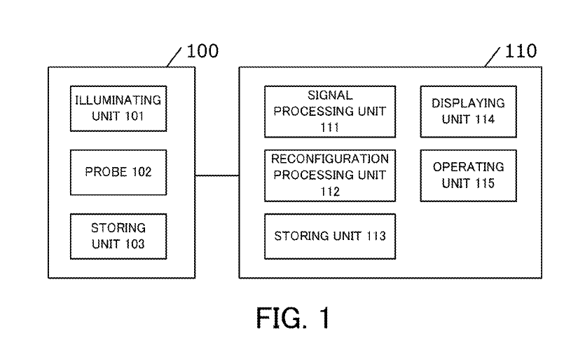

A configuration of an object information acquiring apparatus according to Embodiment 1 will be described with reference to FIG. 1.

The object information acquiring apparatus according to Embodiment 1 is an apparatus in which a probe 100 and an information processing apparatus 110 are connected with a removable cable 120. The probe 100 is constituted by an illuminating unit 101, a probe 102 and a storing unit 103. The information processing apparatus 110 is constituted by a signal processing unit 111, a reconstruction processing unit 112, a storing unit 113, a displaying unit 114 and an operating unit 115.

A configuration of the probe 100 will be described first.

The illuminating unit 101 is an apparatus that generates a pulsed light which irradiates an object. In this embodiment, the pulsed light is generated using a light-emitting diode, a flash lamp or the like.

The illuminating unit 101 may have only the light-emitting port without including the light source, so that the pulsed light is transmitted from an external light source and the light is irradiated via an optical fiber or mirror. If this configuration is used, a laser light, which implements high power, can be used. In the case of using a laser as the light source, various lasers, such as a YAG laser, an alexandrite laser, and a titanium sapphire laser can be used.

The wavelength of the pulsed light is preferably a specific wavelength with which the pulsed light is absorbed by a specific component out of the components constituting the object, and is a wavelength with which the light propagates into the object. In concrete terms, such a wavelength is at least 700 nm and not more than 1200 nm if the object is a living body.

To effectively generate the photoacoustic wave, the light must be irradiated in a sufficiently short time in accordance with the thermal characteristic of the object. When the object is a living body, about 5 to 50 nanoseconds is suitable as the pulse width of the pulsed light generated from the light source.

A probe 102 is a unit that receives an acoustic wave from inside the object, and converts the acoustic wave into an electric signal. The probe 102 also has a function to transmit or receive an ultrasonic echo to/from the object.

The probe is also called an acoustic wave probe, an acoustic wave detector, an acoustic wave receiver or a transducer. The acoustic wave generated from a living body is an ultrasonic wave in the 100 KHz to 100 MHz range, hence an element that can receive this frequency band is used for the acoustic wave detecting element. In concrete terms, a transducer using a piezoelectric phenomenon, a transducer using a resonance of light, a transducer using a change of capacitance or the like can be used.

It is preferable that the acoustic element has high sensitivity and a wide frequency band. In concrete terms, a piezoelectric element using lead zirconate titanate (PZT) and an acoustic element using a high polymer piezoelectric film material, such as polyvinylidene fluoride (PVDF), capacitive micro-machine ultrasonic transducer (CMUT) and a Fabry-Perot interferometer, can be used. However, the acoustic element is not limited to these elements, but may be any element as long as a function of the probe can be implemented.

The storing unit 103 is a storage medium, such as a flash memory, that stores information on light irradiated from the illuminating unit 101 (light quantity, wavelength, size of illuminating region with respect to object surface (e.g. diameter of a circle, horizontal length of a square, expression to indicate a geometric shape) and the like. Hereafter called “irradiation light parameters”). The storing unit 103 may store information that indicates an imaging region of a photoacoustic image (e.g. position, size).

The information processing apparatus 110 will be described next.

The signal processing unit 111 is a unit that performs signal processing on an electric signal outputted from the probe 102, and transmits the processed signal to the reconstruction processing unit 112. The signal processing unit 111 includes, for instance, a function that converts an analog electric signal outputted by the probe 102 into a digital signal and amplifies the digital signal, and a function to control a delay amount. It is preferable that the signal processing unit 111 is connected with a light detecting sensor installed in the illuminating unit 101, for example, and acquires a signal synchronizing with the emission of the pulsed light. The signal processing unit 111 is constituted by an analog amplifier, an A/D converter, a noise reducing circuit and the like, for example.

The reconstruction processing unit 112 is a unit that reconstructs the characteristic information inside the object using a digital signal acquired by the signal processing unit 111 (hereafter called “photoacoustic signal”). The characteristic information is, for example, a distribution of an initial sound pressure of a photoacoustic wave generated inside the object, a light energy absorption density distribution derived from the initial sound pressure, an absorption coefficient distribution, and a concentration distribution of a substance constituting a tissue. The substance concentration is, for example, the oxygen saturation degree in blood, the total hemoglobin concentration, the oxyhemoglobin or deoxyhemoglobin concentration or the like.

The reconstruction processing unit 112 acquires object information inside the object, such as a light absorption coefficient and an oxygen saturation degree based on the photoacoustic signal. In concrete terms, the initial sound pressure distribution inside the three-dimensional object is generated from the collected electric signals. To generate the initial sound pressure distribution, a universal back projection algorithm or a delay and sum algorithm, for example, can be used.

The reconstruction processing unit 112 also generates a three-dimensional light intensity distribution inside the object based on the information on the quantity of light which irradiates the object. The three-dimensional light intensity distribution can be acquired by solving the light diffusion equation based on the information on the two-dimensional light intensity distribution. The absorption coefficient distribution inside the object can be acquired using the initial sound pressure distribution inside the object generated from the photoacoustic signal and the three-dimensional light intensity distribution. Further, the oxygen saturation distribution inside the object can be acquired by computing the absorption coefficient distribution at a plurality of wavelengths.

The storing unit 113 is a unit that stores a digital signal generated by the signal processing unit 111, the image data reconstructed by the reconstruction processing unit 112, and various setting information required for the reconstruction processing. For example, image size, resolution, light wavelength, sound velocity inside the object, background optical coefficient (scattering coefficient and absorption coefficient of background tissue) and the like are stored as the setting information. The storing unit 113 is constituted by such a storage medium as SSD, HDD and flash memory.

The displaying unit 114 is a display that displays image data reconstructed by the reconstruction processing unit 112 and related information.

The operating unit 115 is an interface for instructing the start or end of imaging, setting or cancelling ROI, and setting or changing the setting information required for the reconstruction processing.

Then a method of measuring a living body (object) by the object information acquiring apparatus according to this embodiment will be described next. The object information acquiring apparatus according to this embodiment can generate a plurality of object images by performing measurement using an ultrasonic echo (hereafter “ultrasonic measurement”) and measurement using a photoacoustic wave (hereafter “photoacoustic measurement”) respectively. The former object image is called an “ultrasonic image”, and the latter object image is called a “photoacoustic image”.

When the ultrasonic measurement is performed, the probe 102 transmits an ultrasonic wave to the object, and receives a reflected wave. An electric signal corresponding to the reflected wave is processed by the signal processing unit 111, and is converted into a two-dimensional or three-dimensional B mode image by the reconstruction processing unit 112. Thereby shape information (e.g. information on external shape of object) and structural information (e.g. information on blood vessel shape inside object) on the object can be acquired.

When the photoacoustic measurement is performed, a pulsed light is irradiated from the illuminating unit 101 to the object. When a part of the energy of the light which propagated inside the object is absorbed by a light absorber (e.g. blood), an acoustic wave is generated from this light absorber by thermal expansion. If cancer exist inside the living body, light is specifically absorbed by the newly generated blood vessels of the cancer, in the same manner as blood in other normal segments, and an acoustic wave is generated. The photoacoustic wave generated inside the living body is received by the probe 102.

The signal received by the probe 102 is processed by the signal processing unit 111, and is analyzed by the reconstruction processing unit 112. The analysis result is converted into image data, which represents the characteristic information inside the living body (e.g. initial sound pressure distribution, absorption coefficient distribution).

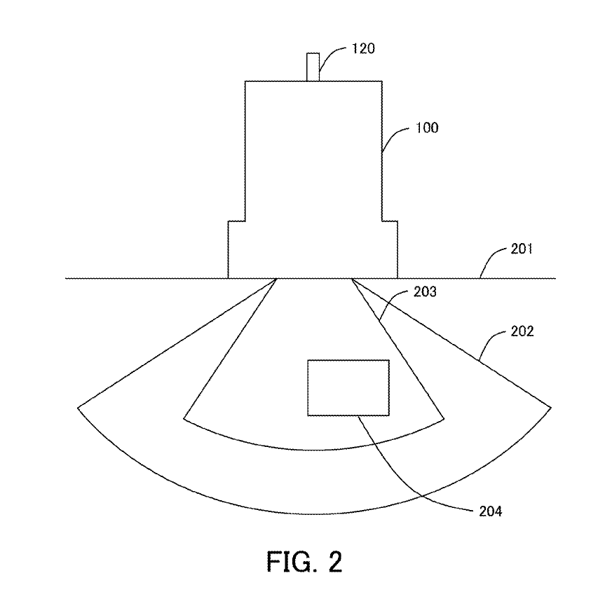

The state of imaging and the imaging ranges of the photoacoustic image and the ultrasonic image inside the object will be described next with reference to FIG. 2.

The reference number 201 indicates a surface layer portion (typically skin) of the object. In this embodiment, imaging is performed in the state of contacting the tip (lower surface) of the probe 100 to the surface layer portion 201.

The reference number 202 indicates a region where an image can be acquired by the ultrasonic measurement (hereafter called “ultrasonic imaging region”). An ultrasonic image corresponding to the region indicated by the reference number 202 can be reconstructed by transmitting an ultrasonic wave from the probe 102 to the object, and receiving the ultrasonic wave reflected inside the object.

The reference number 203 indicates a region, where an image can be acquired by the photoacoustic measurement (photoacoustic imaging region (hereinafter “photoacoustic imaging region”). As described above, the photoacoustic image corresponding to the region indicated by the reference number 203 can be reconstructed by irradiating the object with light from the illuminating unit 101, and the probe 102 receiving the acoustic wave generated inside the object.

Inside the object, as the position becomes distant (deeper) from the irradiation surface of the probe 100, the quantity of light attenuates due to scattering and absorption of light and the S/N ratio of the acoustic wave generated inside the living body drops accordingly. In other words, the accuracy of the final object information that is acquired decreases. Therefore in this embodiment, a threshold is set for the quantity of light that is required to acquire highly accurate object information, and a region to which a quantity of light, which has at least a predetermined value exceeding the threshold can reach, is defined as the photoacoustic imaging region 203 (high accuracy region according to the present invention).

In other words, the object information acquiring apparatus according to this embodiment can provide a photoacoustic image with sufficient accuracy only for a region inside the photoacoustic imaging region 203. This is because a sufficient signal level cannot be acquired outside this region, which makes it difficult to distinguish between noise and a signal.

A simple example of a method of determining the photoacoustic imaging region 203 will be described next.

First it is assumed that a light having uniform light quantity enters the object via the surface of the object so as to form a circle having a predetermined diameter. Then the distribution of the light quantity is simulated based on the background optical coefficients (scattering coefficient and absorption coefficient) of the object, and a region where a quantity of light exceeding a predetermined threshold reaches is calculated, and the calculated region is regarded as the photoacoustic imaging region 203. It is preferable that an actually measured value for each object is used for the background optical coefficient, but a standard value, which is predetermined based on one or more parameters, such as the segment and temperature of the object, age and generate of the examinee, and the wavelength of light, may be used.

The reference number 204 indicates a region of interest (ROI) specified by the operator. The operator specifies the position and size of the ROI via the operating unit 115. In this embodiment, the ROI is a region for displaying the photoacoustic image. In other words, the ROI must be set inside the photoacoustic imaging region 203. In this embodiment, the shape of the ROI 204 is a square, but may be any other shape.

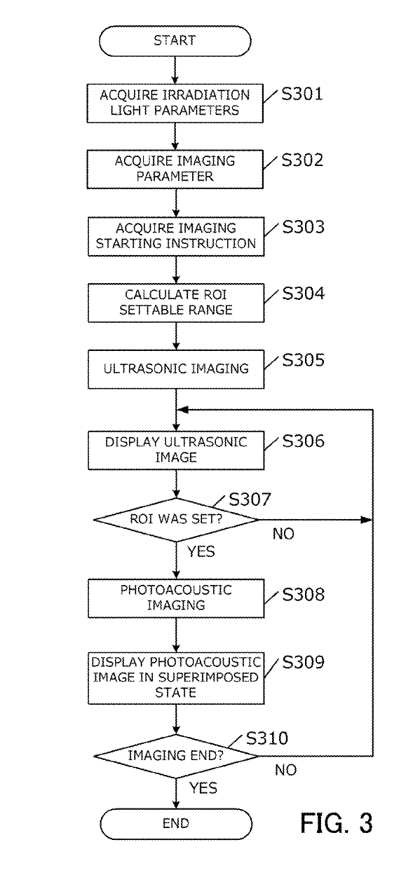

The processing performed by the object information acquiring apparatus according to Embodiment 1 will be described in detail with reference to the flow chart in FIG. 3, which depicts the flow of image processing of the photoacoustic image and the ultrasonic image.

In step S301, the information processing apparatus 110 acquires information (irradiation light parameters) recorded in the storing unit 103 of the probe 100.

Then in step S302, the image processing apparatus 110 acquires imaging parameters which the operator inputted via the operating unit 115. The imaging parameters include information on the examinee (e.g. inspection order, examinee ID, age, gender), information on the image (e.g. image size, resolution), and information on the characteristics of the object (e.g. sound velocity inside object, background optical coefficient), but may be information other than the stated information here.

Then in step S303, the information processing apparatus 110 accepts an imaging start instruction which the operator inputted via the operating unit 115.

Then in step S304, the information processing apparatus 110 calculates the photoacoustic imaging region 203 based on the information (irradiation light parameters and imaging parameters) acquired in steps S301 and S302, and determines a range where the ROI can be set (hereafter called “settable range”) based on the photoacoustic imaging region 203. Thereafter until the end of imaging, the information processing apparatus 110 can accept the setting of the position and the size of the ROI which the operator inputted. If the light wavelength or the background optical coefficient that is used for the photoacoustic imaging is changed, the photoacoustic imaging region 203 may be recalculated so as to update the range where the ROI can be set.

Then in step S305, the ultrasonic imaging is performed. Here the probe 102 transmits an ultrasonic wave to the object, receives the reflected wave thereof, converts the reflected wave into an electric signal, and outputs the electric signal to the signal processing unit 111. Then the signal processing unit 111 performs signal processing on the electric signal, and converts the electric signal into a digital signal.

In step S306, the reconstruction processing unit 112 generates an ultrasonic image based on the acquired digital signal, and the displaying unit 114 displays the ultrasonic image. In this case, the displaying unit 114 displays the settable range of the ROI on the ultrasonic image in the superimposed state.

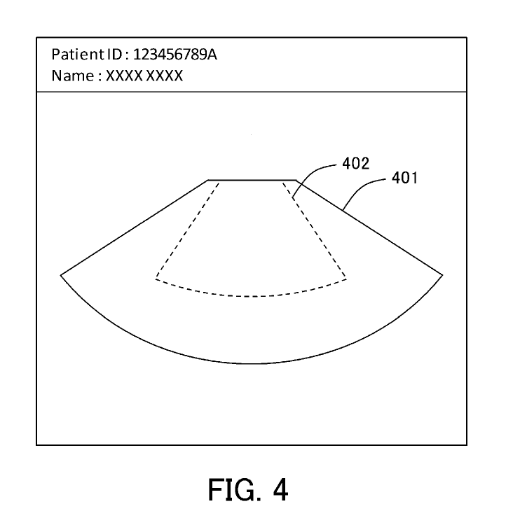

FIG. 4 is an example depicting a settable range of the ROI.

The reference number 401 indicates the ultrasonic image, and the reference number 402 indicates the settable range of the ROI. In this embodiment, the boundary line of the settable range 402 is indicated by the broken line, but another method may be used to indicate the settable range 402, such as displaying the entire settable range 402 using a transparent color.

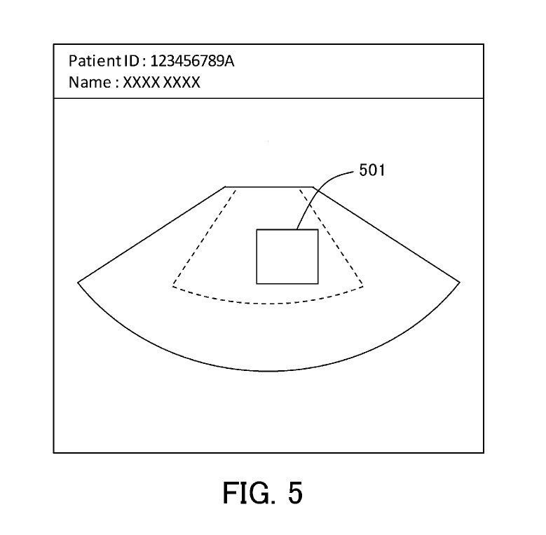

Then in step S307, the information processing apparatus 110 determines whether the ROI is set inside the settable range 402. FIG. 5 is an example of the setting of the ROI. The reference number 501 indicates the ROI that is set. In this embodiment, the ROI 501 is indicated by the solid line, but another method may be used, such as enhancing the entire ROI by a color.

In the ultrasonic imaging apparatus, a track ball and buttons are normally used to specify the position and the size of the ROI, but the ROI may be set using a touch panel or a touch pad.

In the case when the ROI 204 was not set, or when the setting is inappropriate, the processing returns to step S305. The case when the setting of the ROI is inappropriate is, for example, a case when a part or all of the ROI that is set is outside the settable range 402. In such a case, the displaying unit 114 displays a message that the ROI is set at an inappropriate position, and prompts the user to specify the ROI again. Instead of such a display, a different method may be used to notify the user, such as deleting the display of the ROI from the displaying unit 114 or generating a beep sound.

If the ROI is set appropriately, the processing advances to step S308.

In step S308, the photoacoustic imaging is performed. Here the illuminating unit 101 irradiates the object with light, and the probe 102 receives the acoustic wave generated inside the object, and converts the acoustic wave into an electric signal. Further, the signal processing unit 111 performs signal processing on the electric signal outputted from the probe 102, and converts the processed signal into a digital signal.

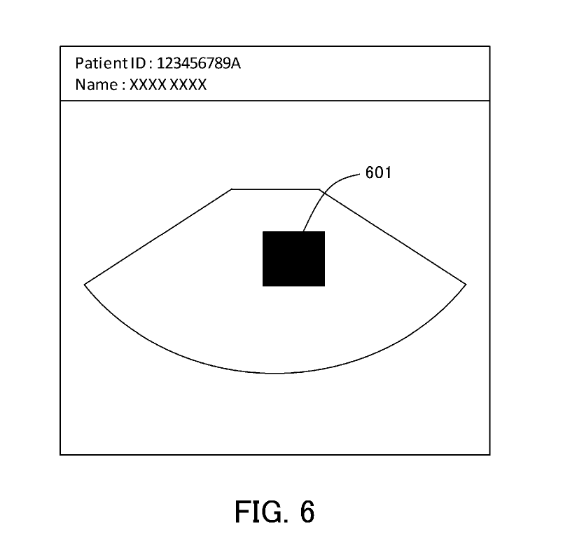

In step S309, the reconstruction processing unit 112 generates the photoacoustic image based on the acquired digital signal, and the displaying unit 114 displays the ultrasonic image and the photoacoustic image in the superimposed state. FIG. 6 is an example of displaying the photoacoustic image in the superimposed state. In FIG. 6, the reference number 601 indicates the photoacoustic image. In other words, the photoacoustic image, in a range corresponding to the ROI, is displayed on the ultrasonic image in the superimposed state.

The photoacoustic image 601 may be made to be transparent and be superimposed on the ultrasonic image inside the ROI. Further, the photoacoustic image 601 may be displayed only at a timing when the operator presses (or does not press) a specific button via the operating unit 115. Furthermore, the displayed image inside the ROI may be switched to a doppler image depending on pressing/not pressing a button.

In step S310, it is determined whether the operator instructed (inputted) the end of imaging. If the operator did not instruct the end of imaging, the processing returns to step S305. If the instruction of the end of imaging is received, the processing ends. If the ROI is not set when imaging ends, the photoacoustic imaging may be performed, and the photoacoustic image may be displayed when requested by the operator after the imaging ends.

As described above, according to Embodiment 1, a region of the ultrasonic image on which the photoacoustic image can be displayed (that is, a region on which the photoacoustic image can be acquired with at least a predetermined accuracy) can be notified to the operator. In particular, an ROI settable region can be displayed on the ultrasonic image in the superimposed state, so the settable range of the ROI can be clearly visible to the operator. If the positional relationship between the determined ROI and the photoacoustic imaging region does not satisfy a predetermined condition (e.g. if the operator set the ROI outside the settable range), this state can be notified to the operator.

In this embodiment, the photoacoustic imaging is performed only when the setting of the ROI has been completed. Thereby the time of irradiating the object with the light can be minimized, and the load on the examinee can be decreased.

In this embodiment, the direction of the irradiating the object with light is fixed, but the light irradiation direction may be changeable by disposing a driving mechanism on the illuminating unit. Then the photoacoustic imaging region can be expanded, and the ROI can be set in a wider range.

If the irradiating direction and the irradiating position of the light can be changed, the photoacoustic imaging region 203 may be determined considering the irradiating direction and the irradiating position. For example, if the light irradiating region is shifted in parallel in the left and right directions in FIG. 2, the photoacoustic imaging region 203 shifts in parallel in the left and right directions. The left edge of the photoacoustic imaging region 203 becomes the same position as the left edge of the imaging region when the driving mechanism is moved to the left limit position, and the right edge thereof becomes the same position as the right edge of the imaging region when the driving mechanism is moved to the right limit position.

Thereby the photoacoustic imaging region 203 can be expanded compared with the case of not disposing the driving mechanism. The irradiating direction and the irradiating position of the light may also be controlled using the driving mechanism, so that the determined ROI is within the photoacoustic imaging region.

A light quantity adjusting unit may be disposed in the illuminating unit 101, so that the quantity of light which irradiates the object can be adjusted. In this case, the photoacoustic imaging region 203 can be calculated considering the quantity of light that is irradiated to the object. The quantity of light that can be irradiated to the object can be determined based on the maximum permissible exposure (MPE).

If the light quantity adjusting unit is disposed, light, of which quantity is the minimum to generate the photoacoustic image, can be irradiated, depending on the determined position of the ROI. By using this configuration, load on the human body when the light is irradiated can be minimized.

### Embodiment 2

In Embodiment 1, a predetermined value is used as the threshold of light quantity to calculate the photoacoustic imaging region. In Embodiment 2, however, the user can set the predetermined threshold.

In Embodiment 2, the photoacoustic imaging region 203 is defined as a region where a light, of which quantity exceeds the threshold inputted by the operator, can reach. In Embodiment 2, unlike Embodiment 1, the reconstruction processing unit 112 reconstructs the photoacoustic image in a region that is the same as the ultrasonic imaging region 202.

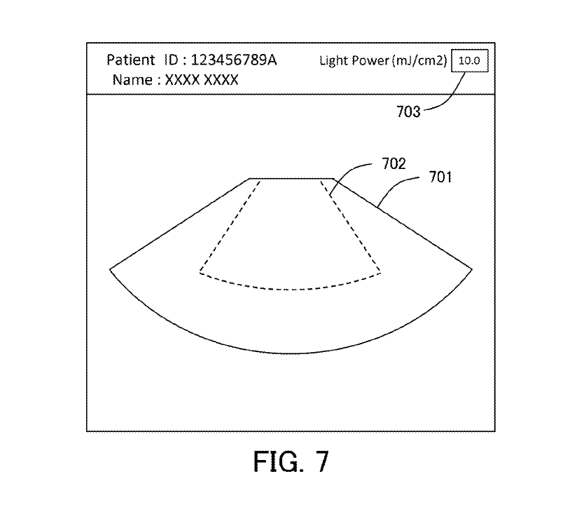

FIG. 7 is an example of the ROI setting screen according to Embodiment 2. The reference number 701 indicates a range of the ultrasonic image, and the reference number 702 indicates the settable range of the ROI. In this example, the boundary line of the settable range 702 is indicated by a broken line, but another method may be used to indicate the setting range 702, such as displaying the entire settable range 702 using a transparent color.

The reference number 703 indicates a text box to input the threshold of the light quantity when the photoacoustic imaging region 203 is determined. If the operator sets a value in the text box 703, the region where the light, of which quantity exceeds the inputted value, can reach is calculated as the settable range 702. In other words, the settable range 702 dynamically changes in accordance with the inputted value.

According to Embodiment 2, the settable range is visually displayed in accordance with the light quantity that is set by the operator. By this configuration, the accuracy of the photoacoustic image can be visually recognized.

### Embodiment 3

In Embodiments 1 and 2, it is determined in step S307 whether the positional relationship between the specified ROI and the photoacoustic imaging region satisfies a predetermined condition, and an error is displayed if the condition is not satisfied. In Embodiment 3, on the other hand, this determination is not performed.

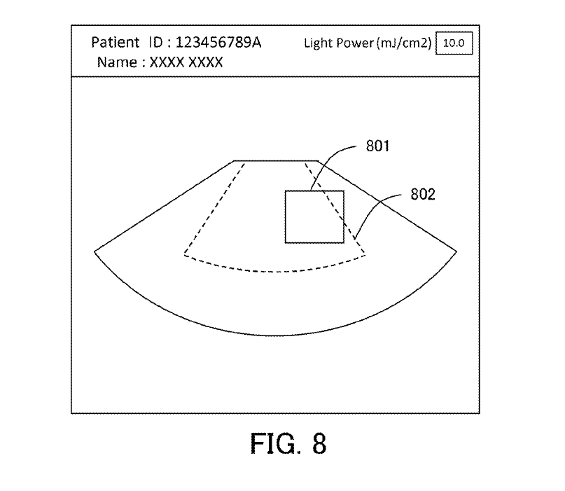

In Embodiment 3, it is not determined in step S307 whether the ROI is set in an inappropriate position, and the processing advances to step S308 if the ROI is set. FIG. 8 is a display example when the ROI is set. The reference number 801 is a boundary line of the ROI. In this example, the boundary line is indicated by the solid line, but another method may be used, such as coloring the entire ROI. The ROI may be set outside the region in the settable range 802.

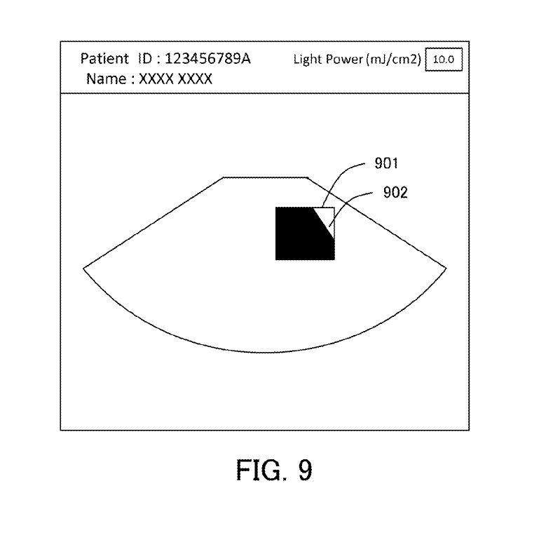

In Embodiment 3, the photoacoustic image and the ultrasonic image are displayed in the superimposed state in step S309. FIG. 9 is an example when the photoacoustic image is displayed in the superimposed state. The reference number 901 indicates the photoacoustic image. The photoacoustic image is displayed only in the region that is set as the ROI in the superimposed state.

The reference number 902 indicates a region that is inside the ROI and outside the photoacoustic imaging region. This region is a region where a predetermined quantity of light does not reach (hereafter called “low accuracy image region”). In Embodiment 3, the photoacoustic image is displayed in the superimposed state, even on the low accuracy image region 902.

In this case, the positions and the sizes of the photoacoustic imaging region and the other region (low accuracy image region) may be distinguished and indicated on the image. If only a part of the determined ROI is outside the photoacoustic imaging region, the region existing outside the photoacoustic imaging region may be indicated, and notification that a predetermined accuracy cannot be acquired for this region may be displayed.

For the low accuracy image region 902, image processing (filter processing) to indicate that the accuracy of this region is low may be performed. For example, for pixels or voxels existing in the low accuracy image region 902, color or gradation according to the light quantity value may be displayed.

The photoacoustic image 901 may be made to be transparent and be superimposed on the ultrasonic image inside the ROI. Further, the photoacoustic image 901 may be displayed only at a timing when the operator presses (or does not press) a specific button via the operating unit 115. Furthermore, the displayed image inside the ROI may be switched to the doppler image, depending on pressing/not pressing a button.

As described above, according to Embodiment 3, the operator can set the ROI outside the photoacoustic imaging region. Further, by performing image processing to present information on the location of the low accuracy image region and on the accuracy of the photoacoustic image, the operator can intuitively know the accuracy of the photoacoustic image.

In Embodiment 3, the photoacoustic image in the low accuracy image region is superimposed on the ultrasonic image, but the operator may select whether the images are superimposed or not. The operator may also select whether the photoacoustic image in the low accuracy image region is displayed on not.

Furthermore, Embodiment 3 and Embodiment 2 may be combined and the threshold of the light quantity may be variable.

### Other Embodiments

Description on each embodiment is an example that describes the present invention, and the present invention can be carried out by appropriately changing or combining the above embodiments within a range not departing from the essence of the invention.

For example, the present invention may be carried out as an information processing apparatus, or as an object information acquiring apparatus that carries out at least a part of the above mentioned processing. The present invention may also be carried out as an information processing method or as an object information acquiring method that includes at least a part of the above mentioned processing. The above processing or units may be freely combined within a scope of not generating technical inconsistencies.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-080603, filed on Apr. 14, 2017, which is hereby incorporated by reference herein in its entirety.

What is claimed is:

1. An information processing apparatus, comprising:
a first acquiring unit configured to acquire a photoacoustic image that is an image generated on a basis of an acoustic wave which is generated by irradiating an object with light;
a second acquiring unit configured to acquire an ultrasonic image that is an image generated on a basis of a reflected wave of an ultrasonic wave transmitted to the object;
a determining unit configured to determine a high accuracy region that is a region in which information is acquired with at least a predetermined value of accuracy in the photoacoustic image;
an inputting unit configured to receive a designation of a region of interest on the ultrasonic image; and
a displaying unit configured to display the ultrasonic image and the photoacoustic image corresponding to the region of interest, wherein
when the inputting unit receives the designation of the region of interest, the displaying unit displays the position of the high accuracy region on the ultrasonic image in a superimposed state.

2. The information processing apparatus according to claim 1, wherein
in a case a positional relationship between the specified region of interest and the high accuracy region satisfies a predetermined condition, the displaying unit displays the photoacoustic image corresponding to the region of interest.

3. The information processing apparatus according to claim 2, wherein
in a case the positional relationship between the specified region of interest and the high accuracy region does not satisfy a predetermined condition, the displaying unit displays a notification that the photoacoustic image cannot be displayed.

4. The information processing apparatus according to claim 3, wherein
in a case the positional relationship between the specified region of interest and the high accuracy region does not satisfy a predetermined condition, the displaying unit displays a notification to prompt specifying the region of interest again.

5. The information processing apparatus according to claim 1, wherein
in a case the high accuracy region is included in at least a part of the specified region of interest, the displaying unit displays the photoacoustic image corresponding to the region of interest in a manner which allows distinguishing the high accuracy region from other regions.

6. The information processing apparatus according to claim 1, wherein
the displaying unit performs filter processing to add information on the accuracy of the photoacoustic image to the photoacoustic image corresponding to the region of interest.

7. An object information acquiring apparatus, comprising:
an irradiating unit configured to irradiate an object with light;
a receiving unit configured to receive an acoustic wave generated in the object;
a transmitting/receiving unit configured to transmit an ultrasonic wave to the object and to receive a reflected wave, which is the ultrasonic wave reflected inside the object; and
the information processing apparatus according to claim 1.

8. The object information acquiring apparatus according to claim 7, wherein
in a case a positional relationship between the specified region of interest and the high accuracy region satisfies a predetermined condition,
the irradiating unit irradiates the object with light, and
the first acquiring unit acquires the photoacoustic image.

9. The object information acquiring apparatus according to claim 7, further comprising
a unit configured to determine an irradiation region that is a region, to which the light can reach, inside the object, wherein
the determining unit determines the high accuracy region for the irradiation region.

10. The object information acquiring apparatus according to claim 7, wherein
the irradiating unit includes a light quantity adjusting unit configured to change an intensity of the light, and emits the light using a minimum light quantity that can generate the photoacoustic image, for the specified region of interest.

11. An information processing method, comprising:
a first acquiring step of acquiring a photoacoustic image that is an image generated on a basis of an acoustic wave which is generated by irradiating an object with light;
a second acquiring step of acquiring an ultrasonic image that is an image generated on a basis of a reflected wave of an ultrasonic wave transmitted to the object;
a determining step of determining a high accuracy region that is a region in which information is acquired with at least a predetermined value of accuracy in the photoacoustic image;
an inputting step of receiving a designation of a region of interest in the ultrasonic image; and
a displaying step of displaying the ultrasonic image and the photoacoustic image corresponding to the region of interest by using the displaying unit, wherein
when the designation of the region of interest is received in the inputting step, the displaying unit displays the position of the high accuracy region on the ultrasonic image in a superimposed state.

12. The information processing method according to claim 11, wherein
in a case a positional relationship between the specified region of interest and the high accuracy region satisfies a predetermined condition, the photoacoustic image corresponding to the region of interest is displayed in the displaying step.

13. The information processing method according to claim 12, wherein
in a case the positional relationship between the specified region of interest and the high accuracy region does not satisfy a predetermined condition, the displaying unit displays a notification that the photoacoustic image cannot be displayed.

14. The information processing method according to claim 13, wherein
in a case the positional relationship between the specified region of interest and the high accuracy region does not satisfy a predetermined condition, the displaying unit displays a notification to prompt specifying the region of interest again.

15. The information processing method according to claim 11, wherein
when the high accuracy region is included in at least a part of the specified region of interest, the photoacoustic image corresponding to the region of interest is displayed in a manner which allows distinguishing the high accuracy region from other regions in the displaying step.
